(19) United States
(12) Patent Application Publication
(10) Pub. No.: US 2010/0088451 A1
(43) Pub. Date: Apr. 8, 2010

(54) ARCHITECTURE VERIFYING APPARATUS, ARCHITECTURE VERIFYING METHOD, AND MEDIUM STORING ARCHITECTURE VERIFYING PROGRAM

(75) Inventor: Atsushi Kageshima, Yokohama-Shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/553,034

(22) Filed: Sep. 2, 2009

(30) Foreign Application Priority Data
Oct. 3, 2008 (JP) 2008-258731

(51) Int. Cl. G06F 13/14

(52) U.S. Cl. 710/305

(57) ABSTRACT

An architecture verifying apparatus includes an inputting unit receiving limitation information, a bus monitor monitoring a bus transaction to obtain bus transaction information, a module monitor monitoring a reception transaction, processing, and a transmission transaction to obtain reception transaction information, processing information, and transmission transaction information, an architecture information generator associating the limitation information and the bus transaction information with the reception transaction information, the processing information, and the transmission transaction information to generate architecture information, and an outputting unit supplying the architecture information.

### CROSS-REFERENCE TO RELATED APPLICATION

This application is based upon and claims the benefit of priority from the prior Japanese Patent Application No. 2008-258731, filed on Oct. 3, 2008; the entire contents of which are incorporated herein by reference.

### BACKGROUND OF THE INVENTION

1. Field of the Invention

The present invention relates to an architecture verifying apparatus, an architecture verifying method, and a medium storing an architecture verifying program, particularly to the apparatus, the method, and the medium that are used as tools for assisting architecture analysis of a system LSI (Large Scale Integration).

2. Related Art Generally, performance of the system LSI largely depends on an architecture of a system used. Accordingly, it is necessary that the architecture of the system be analyzed in order to evaluate the performance of the system LSI.

However, it is necessary to analyze the architecture in consideration of a large amount of parameters such as selection of a processor constituting the system, allocation of each piece of processing performed on the system to the processor, a processing time of each piece of processing allocated to the processor, a data transfer time on a bus, a bus priority, a bus width, a method to arbitrate the buses, a type of the processor used, and an operating frequency of the processor used. Accordingly, it is actually impossible that a user determines the architecture satisfying specifications.

On the other hand, conventionally, an architecture verifying apparatus is known as a tool used for assisting the architecture analysis when the user determines the architecture. In the conventional architecture verifying apparatus, a model for realizing an candidate architecture is operated on a simulator or a real machine, bus transaction information relating to a bus transaction issued to the bus, bus use waiting information due to bus competition, and bus throughput latency information are stored, and these information are graphically displayed, thereby assisting a determination whether the architecture satisfies the specifications and an evaluation of the architecture.

However, the user hardly makes the determination whether the architecture satisfies the specification only from the pieces of information. Therefore, a combination of the application information and the bus transaction information is well known as a technique of solving this problem (see Japanese Patent laid-open Publication No. 2007-207120). According to the technique disclosed in Japanese Patent laid-open Publication No. 2007-207120, the user can easily make the determination whether the architecture satisfies the specifications.

However, in the technique disclosed in Japanese Patent laid-open Publication No. 2007-207120, information indicating how the architecture that does not satisfy the specifications is changed in order to satisfy the specifications is not given to the user. Therefore, it is necessary that the user determines the architecture satisfying the specifications by trial and error. As a result, a burden on the user is increased in the architecture analysis, and the time necessary for the architecture analysis is lengthened.

### BRIEF SUMMARY OF THE INVENTION

According to a first aspect of the present invention, there is provided an architecture verifying apparatus comprising:

an inputting unit configured to receive limitation information on a processing time of an architecture comprising a plurality of modules and a bus;

a bus monitor configured to monitor a bus transaction to obtain bus transaction information, the bus transaction being issued when the module utilizes the bus;

a module monitor configured to monitor a reception transaction issued when the module receives data, processing performed to the data by the module, and a transmission transaction issued when the module transmits the data to obtain reception transaction information on the reception transaction, processing information indicating processing contents and a processing time of the module, and transmission transaction information on the transmission transaction;

an architecture information generator configured to associate the limitation information received by the inputting unit and the bus transaction information obtained by the bus monitor with the reception transaction information, the processing information, and the transmission transaction information obtained by the module to generate architecture information; and

an outputting unit configured to supply the architecture information generated by the architecture information generator.

According to a second aspect of the present invention, there is provided an architecture verifying method comprising:

receiving limitation information on a processing time of an architecture comprising a plurality of modules and a bus;

monitoring a bus transaction to obtain bus transaction information, the bus transaction being issued when the module utilizes the bus;

monitoring a reception transaction issued when the module receives data, processing performed to the data by the module, and a transmission transaction issued when the module transmits the data to obtain reception transaction information on the reception transaction, processing information indicating processing contents and a processing time of the module, and transmission transaction information on the transmission transaction;

associating the limitation information and the bus transaction information with the reception transaction information, processing information, and the transmission transaction information to generate architecture information; and

supplying the architecture information.

According to a third aspect of the present invention, there is provided a medium storing architecture verifying program comprising:

an inputting instruction configured to receive limitation information on a processing time of an architecture comprising a plurality of modules and a bus;

a bus monitoring instruction configured to monitor a bus transaction to obtain bus transaction information, the bus transaction being issued when the module utilizes the bus;

a module monitoring instruction configured to monitor a reception transaction issued when the module receives data, processing performed to the data by the module, and a transmission transaction issued when the module transmits the data to obtain reception transaction information on the reception transaction, processing information indicating processing contents and a processing time of the module, and transmission transaction information on the transmission transaction;

an architecture information generator configured to associate the limitation information received by the inputting instruction and the bus transaction information obtained by the bus monitoring instruction with the reception transaction information, processing information, and the transmission transaction information obtained by the module to generate architecture information; and

an outputting instruction configured to supply the architecture information generated by the architecture information generator.

### BRIEF DESCRIPTION OF THE DRAWINGS

FIG. 1 is a block diagram illustrating a system configuration including an architecture verifying apparatus 10 of the first embodiment of the present invention.

FIG. 2 is a block diagram illustrating architecture that becomes a verification target of the architecture verifying apparatus 10 of the first embodiment of the present invention.

FIG. 3A is a block diagram schematically illustrating image processing performed in the architecture of FIG. 2.

FIG. 3B is a block diagram schematically illustrating sound processing performed in the architecture of FIG. 2.

FIG. 4 is a block diagram illustrating a configuration of the architecture verifying apparatus 10 of the first embodiment of the present invention.

FIG. 5 is a flowchart illustrating processing procedures of the architecture verification processing of the first embodiment of the present invention.

FIG. 6 schematically illustrates an output example of the first embodiment of the present invention.

FIG. 7 is a block diagram illustrating the configuration of the architecture verifying apparatus 10 of the second embodiment of the present invention.

FIG. 8 is a flowchart illustrating processing procedures of the architecture verification processing of the second embodiment of the present invention.

FIG. 9 schematically illustrates an output example of the second embodiment of the present invention.

FIG. 10 is a block diagram illustrating the configuration of the architecture verifying apparatus 10 of the third embodiment of the present invention.

FIG. 11 is a flowchart illustrating processing procedures of the architecture verification processing of the third embodiment of the present invention.

FIG. 12 schematically illustrates an output example of the third embodiment of the present invention.

FIG. 13 is a flowchart illustrating processing procedures of the architecture proposal creating unit 143 in the architecture proposal creation processing (Step S1102 of FIG. 11) when the module processing time is fed as the parameter.

FIG. 14 illustrates the architecture proposal (the architecture proposal that is not included in the analyzed result 15b) in which the case 1 and case 3 satisfy the specifications while the case 2 does not satisfy the specifications.

FIG. 15 is a flowchart illustrating processing procedures of the architecture proposal creating unit 143 in the architecture proposal creation processing (Step S1102 of FIG. 11) when the bus priority is fed as the parameter.

FIG. 16 illustrates the architecture proposal (the architecture proposal that is included in the analyzed result 15b) in which the case 1 to case 3 satisfy the specifications.

FIG. 17 is a flowchart illustrating processing procedures of the architecture proposal creating unit 143 in the architecture proposal creation processing (Step S1102 of FIG. 11) when the bus width is fed as the parameter.

FIG. 18 schematically illustrates an output example of the third embodiment of the present invention when the architecture proposal creation processing of FIG. 17 is performed.

FIG. 19 is a flowchart illustrating processing procedures of the architecture proposal creating unit 143 in the architecture proposal creation processing (Step S1102 of FIG. 11) when the bus configuration is fed as the parameter.

FIGS. 20 and 21 schematically illustrate output examples of the third embodiment of the present invention when the architecture proposal creation processing of FIG. 19 is performed.

FIG. 22 schematically illustrates an output example of the third embodiment of the present invention when the architecture proposal creation processing of FIG. 15 is performed.

### DETAILED DESCRIPTION OF THE INVENTION

Exemplary embodiments of the present invention will be described below with reference to the drawings. The following embodiments of the present invention are described only by way of example, and the scope of the present invention is not limited to the embodiments of the present invention.

### First Embodiment

An architecture verifying apparatus according to a first embodiment of the present invention will be described below. The architecture verifying apparatus of the first embodiment of the present invention generates architecture information from information obtained by monitoring architecture, and the architecture verification apparatus supplies the architecture information.

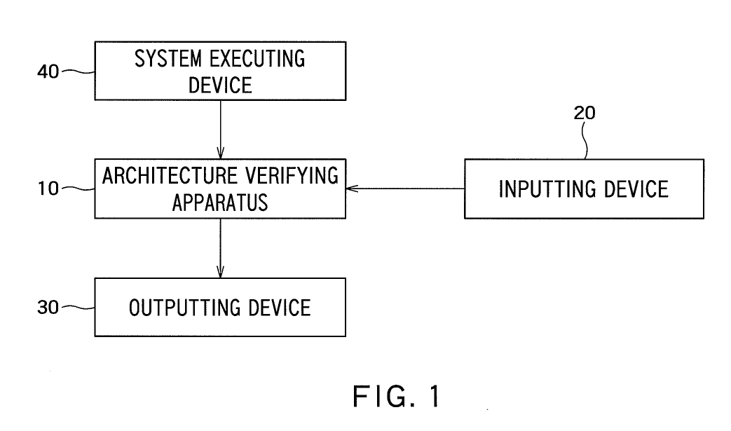

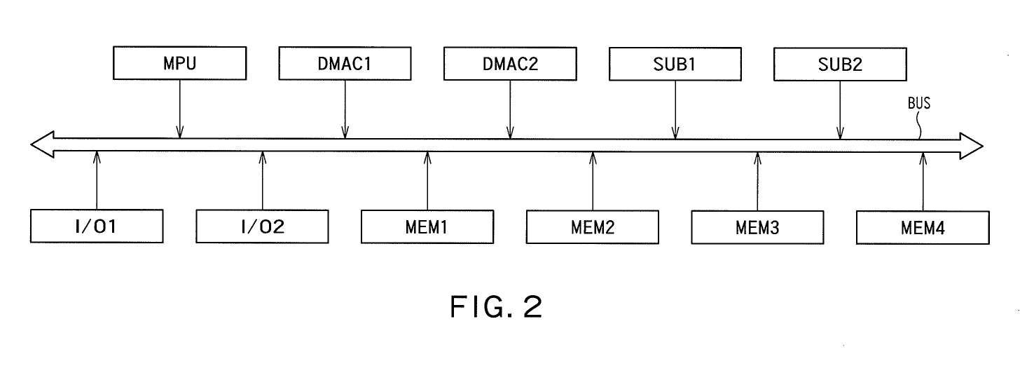

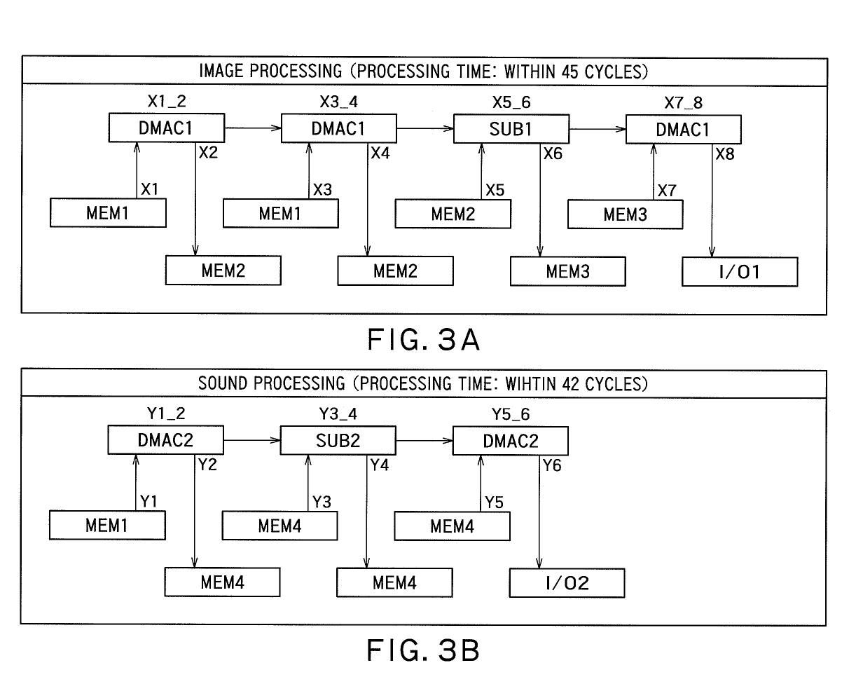

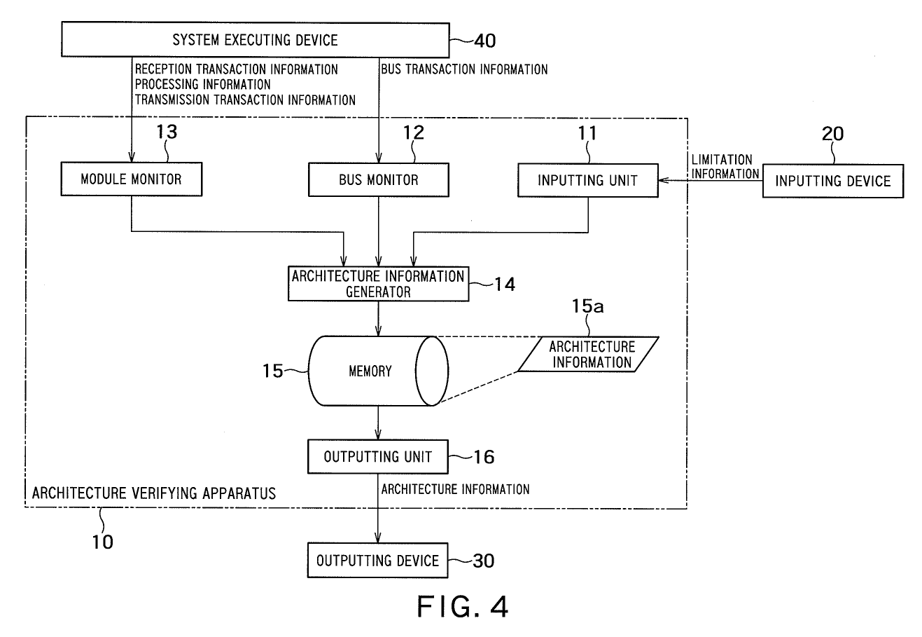

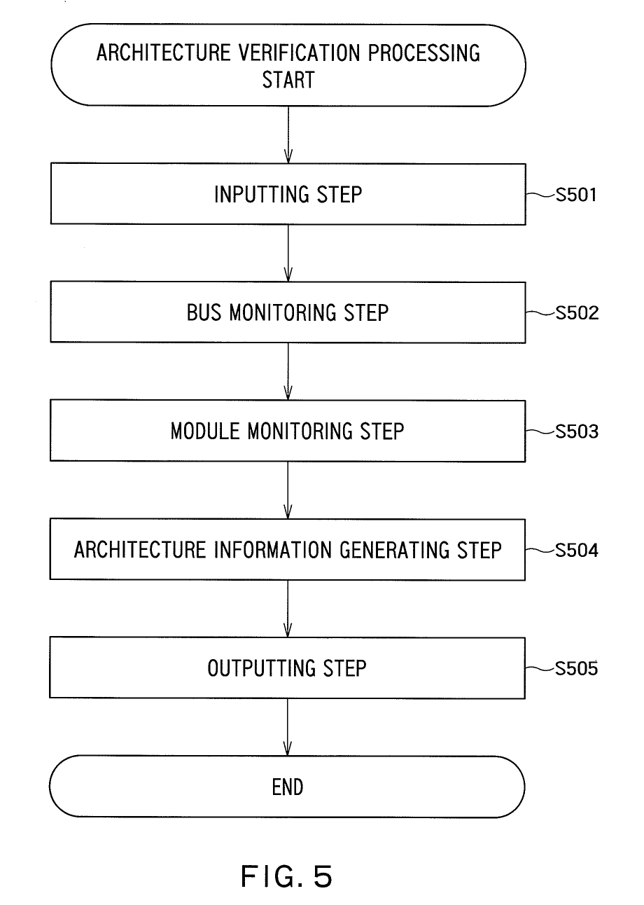

A configuration of the architecture verifying apparatus of the first embodiment of the present invention will be described with reference to FIGS. 1 to 4. FIG. 1 is a block diagram illustrating a system configuration including an architecture verifying apparatus 10 of the first embodiment of the present invention. FIG. 2 is a block diagram illustrating architecture that becomes a verification target of the architecture verifying apparatus 10 of the first embodiment of the present invention. FIG. 3 is a block diagram schematically illustrating image processing and sound processing, which are performed in the architecture of FIG. 2. FIG. 4 is a block diagram illustrating a configuration of the architecture verifying apparatus 10 of the first embodiment of the present invention.

Referring to FIG. 1, the architecture verifying apparatus 10 of the first embodiment of the present invention is connected to an inputting device 20 such as a keyboard and a mouse, an outputting device 30 such as a liquid crystal display, a printer, and a network device, and a system executing device 40 such as a simulator and a real machine. The architecture to be verified by the architecture verifying apparatus 10 is operated on the system executing device 40 and configured to perform plural pieces of processing (such as image processing and sound processing) in parallel.

Referring to FIG. 2, the architecture to be verified by the architecture verifying apparatus 10 of the first embodiment of the present invention includes plural modules (processor MPU, memory controllers DMAC1 and DMAC2, sub-processors SUB1 and SUB2, memories MEM1 to MEM4, and input and output (input/output) interfaces I/O1 and I/O2) and a bus. The modules are connected to one another through the bus. Each of the modules is operated as an initiator module or a target module. The modules perform a series of pieces of processing by exchanging transactions. At this time, each module issues a bus transaction for utilizing the bus, a reception transaction for receiving data, and a transmission transaction for transmitting the data, and performs processing to the data. The modules may be connected to one another through plural buses by a bus bridge.

Referring to FIG. 3A, the image processing performed in the architecture of FIG. 2 is explained. The memory controller DMAC1 issues a reception transaction X1 when reading out image data from the memory MEM1. The memory controller DMAC1 performs processing X1_2 when transferring the image data to a work area. The memory controller DMAC1 issues a transmission transaction X2 when writing the image data into the memory MEM2. The memory controller DMAC1 repeats the similar processing to issue a reception transaction X3, to perform processing X3_4, and to issue a transmission transaction X4. The sub-processor SUB1 issues a reception transaction X5 when reading out the image data from the memory MEM2. The sub-processor SUB1 performs processing X5_6 when performing image processing to the image data. The sub-processor SUB1 issues a transmission transaction X6 when writing the processed image data into the memory MEM3. The memory controller DMAC1 issues a reception transaction X7 when reading out the image data from the memory MEM3. The memory controller DMAC1 performs processing X7_8 when externally supplying the image data. The memory controller DMAC1 issues a transmission transaction X8 when transmitting the image data to the input/output interface I/O1. A time limitation to the series of pieces of processing is within 45 cycles.

Referring to FIG. 3B, sound processing performed in the architecture of FIG. 2 is explained. The memory controller DMAC2 issues a reception transaction Y1 when reading out sound data from the memory MEM1. The memory controller DMAC2 performs processing Y1_2 when transferring the sound data to the work area. The memory controller DMAC2 issues a transmission transaction Y2 when writing the image data into the memory MEM4. The sub-processor SUB2 issues a reception transaction Y3 when reading out the sound data from the memory MEM4. The sub-processor SUB2 performs processing Y3_4 when performing sound processing to the sound data. The sub-processor SUB2 issues a transmission transaction Y4 when writing the processed sound data into the memory MEM4. The memory controller DMAC2 issues a reception transaction Y5 when reading out the sound data from the memory MEM4. The memory controller DMAC2 performs processing Y5_6 when externally supplying the sound data. The sub-processor SUB2 issues a transmission transaction Y6 when transmitting the sound data to the input/output interface I/O2. A time limitation to the series of pieces of processing is within 42 cycles.

Referring to FIG. 4, the architecture verifying apparatus 10 of the first embodiment of the present invention includes an inputting unit 11, a bus monitor 12, a module monitor 13, an architecture information generator 14, a memory 15, and an outputting unit 16.

Referring to FIG. 4, the inputting unit 11 is configured to receive limitation information on a processing time of the architecture from the inputting device 20.

Referring to FIG. 4, the bus monitor 12 is configured to monitor the bus transaction issued in the architecture operated on the system executing device 40 and to obtain bus transaction information (pair information indicating a combination of the initiator module and target module relating to the bus transaction, bus use waiting information due to bus competition, bus throughput latency information, the amount of bus transaction data, and the number of transfer times) relating to the bus transaction. For example, the bus monitor 12 obtains the pair information from the initiator module issuing the bus transaction and the target module corresponding to an address included in the bus transaction. Particularly, in the case of the bus transaction through the plural buses by the bus bridge, the bus monitor 12 monitors the address included in the bus transaction, the bus monitor unit 12 tracks back the bus transaction to an address space possessed by the bus bridge or the bus transaction transmitted to another bus through the bus bridge, and the bus monitor unit 12 obtains the pair information indicating combinations of all the related modules.

Referring to FIG. 4, the module monitor 13 is configured to monitor the reception transaction and the transmission transaction, which are issued in the architecture operated on the system executing device 40, and to monitor the processing performed in the architecture operated on the system executing device 40, and to obtain the reception transaction information, processing information, and transmission transaction information. For example, the module monitor 13 obtains the order of the pieces of the processing constituting the series of pieces of the processing and identification information (for example, “MPU” when the processor MPU is used) of the module used in each piece of the processing from information of an application program executed on the processor MPU of FIG. 2, the processor MPU controlling the series of pieces of processing. The module monitor 13 monitors a necessary time until a command of an end portion of codes of the application program corresponding to the processing is performed since a command of a start portion of codes of the application program is executed with respect to the processing performed on the processor MPU or the sub-processor SUB1 or SUB2, whereby the module monitor 13 obtains a processing time of the module spent for the processing, and the reception transaction information and the transmission transaction information relating to the processing. On the other hand, the module monitor 13 monitors the processing until the hardware performing the processing is ended since the hardware is operated by an external factor with respect to the processing performed on hardware, whereby the module monitor 13 obtains the necessary time spent for the processing, the reception transaction information and the transmission transaction information relating to the processing.

Referring to FIG. 4, the architecture information generator 14 is configured to associate the limitation information received by the inputting unit 11 and the bus transaction information obtained by the bus monitor 12 with the reception transaction information, the processing information, and the transmission transaction information, which are obtained by the module monitor 13, to generate architecture information 15a, and to write the architecture information 15a into the memory 15. For example, for each of the plural architectures, the architecture information generator 14 groups the reception transaction information, processing information, and transmission transaction information together with respect to one piece of processing, the architecture information generator 14 combines the pieces of bus transaction information among plural groups, and the architecture information generator 14 set the limitation information as a threshold to generate the architecture information 15a.

Referring to FIG. 4, the memory 15 is configured to store the architecture information 15a generated by the architecture information generator 14. The memory 15 is also configured to act as a working memory of the architecture information generator 14.

Referring to FIG. 4, the outputting unit 16 is configured to supply the architecture information 15a stored in the memory 15 to the outputting device 30.

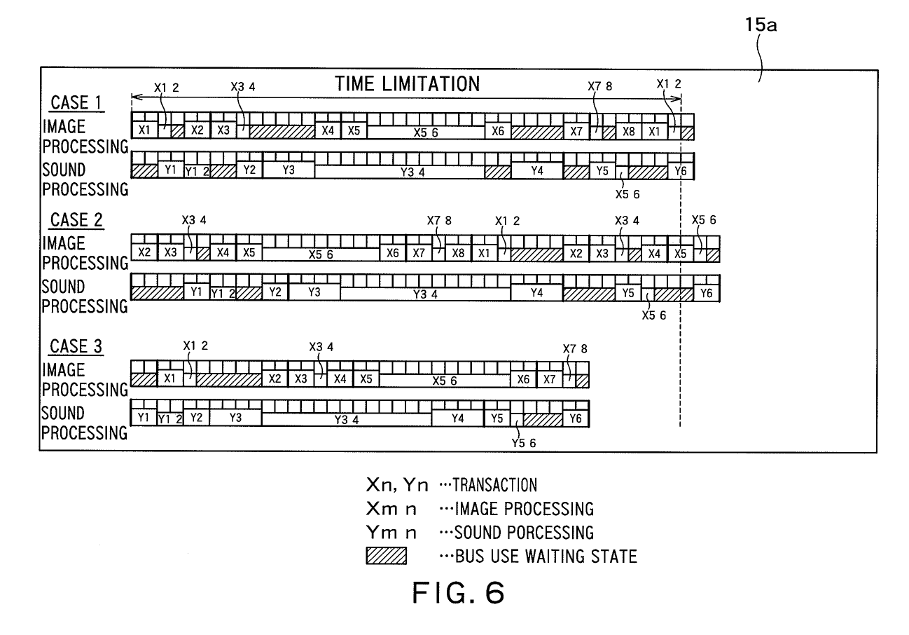

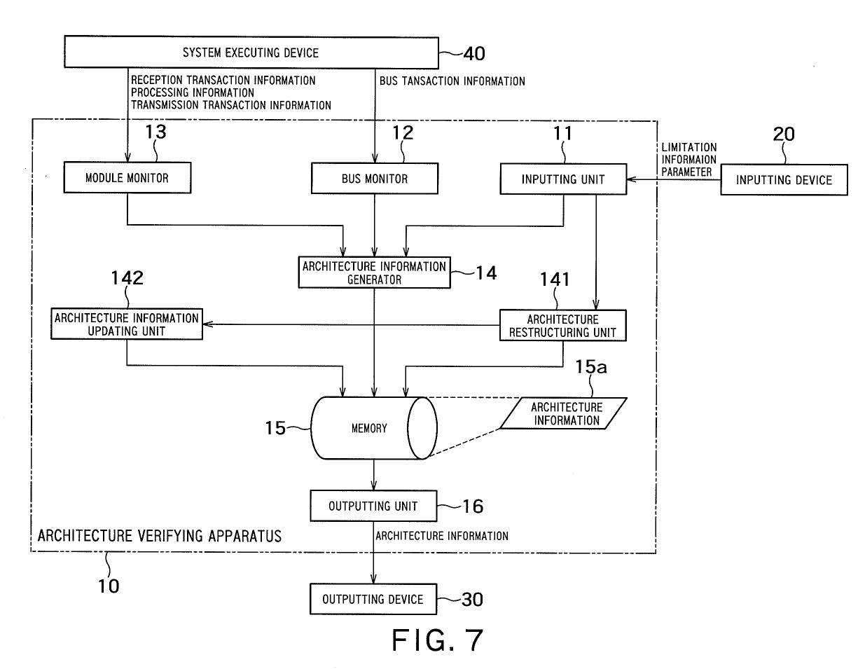

The processing performed by the architecture verifying apparatus of the first embodiment of the present invention will be described with reference to FIGS. 5 and 6. FIG. 5 is a flowchart illustrating processing procedures of the architecture verification processing of the first embodiment of the present invention. FIG. 6 schematically illustrates an output example of the first embodiment of the present invention.

Referring to FIG. 5, in the architecture verification processing of the first embodiment of the present invention, an inputting step is performed (Step S501). In the inputting step (Step S501), the limitation information is received by the inputting unit 11 from the inputting device 20.

Then, a bus monitoring step is performed (Step S502). In the bus monitoring step (Step S502), the bus monitor 12 monitors the bus transaction issued in the architecture, and the bus monitor 12 obtains the bus transaction information.

Then, a module monitoring step is performed (Step S503). In the module monitoring step (Step S503), the module monitor 13 monitors the reception transaction and transmission transaction, which are issued in the architecture, and the processing performed in the architecture, and the module monitor 13 obtains the reception transaction information, the processing information, and the transmission transaction information.

Then, an architecture information generating step is performed (Step S504). In the architecture information generating step (Step S504), the architecture information generator 14 associates the limitation information received in the inputting step (Step S501) and the bus transaction information obtained in the bus monitoring step (Step S502) with the reception transaction information, the processing information, and the transmission transaction information, which are obtained in the module monitoring step (Step S503), to generate the architecture information 15a, and the architecture information generator 14 writes the architecture information 15a into the memory 15.

Then, an outputting step is performed (Step S505). In the outputting step (Step S505), the outputting unit 16 supplies the architecture information 15a stored in the memory 15 in the architecture information generating step (Step S504) to the outputting device 30. At this time, the outputting unit 16 supplies the architecture information 15a illustrated in FIG. 6 to the outputting device 30. In FIG. 6, a case 1 and a case 2 do not satisfy specifications, and a case 3 satisfies the specifications. As used herein, the case shall means a combination of the processing (hereinafter referred to as “focused processing”) to which the time limitation is given and another piece of the processing. The cases differ from one another in timing of the performed processing and timing of the issued transaction in a relationship between the focused processing and another piece of the processing. In FIG. 6, the letters Xn and Yn designate transactions, the letter Xm_n designates image processing, the letter Ym_n designates sound processing, and a hatched portion indicates a bus use waiting state due to the bus competition.

Referring to FIG. 5, the architecture verification processing of the first embodiment of the present invention is ended after the output process (Step S505).

In the first embodiment of the present invention, the outputting unit 16 is connected to the outputting device 30. Alternatively, the outputting unit 16 may be connected to the database. In such cases, the outputting unit 16 stores the architecture information 15a as a file in the database.

In the first embodiment of the present invention, the outputting unit 16 supplies the architecture information 15a stored in the memory 15 to the outputting device 30. Alternatively, the outputting unit 16 may dynamically supply the architecture information 15a generated by the architecture information generator 14 to the outputting device 30. In such cases, the memory 15 is not required.

According to the first embodiment of the present invention, as illustrated in FIG. 4, the architecture verifying apparatus 10 monitors the transaction and processing, which are issued in the architecture, the architecture verifying apparatus 10 obtains the transaction information and the processing information, the architecture verifying apparatus 10 associates the transaction information and the processing information with each other to generate the architecture information, and the architecture verifying apparatus 10 supplies the architecture information to the outputting device 30. Therefore, the burden of the user can be reduced in the architecture analysis, and the work time necessary for the analysis can be shortened. Particularly, the user can distinguish the processing having the long processing time from other pieces of the processing based on the architecture information of FIG. 6, and the user can easily design the architecture satisfying the specifications.

### Second Embodiment

An architecture verifying apparatus according to a second embodiment of the present invention will be described below. The architecture verifying apparatus of the second embodiment of the present invention updates existing architecture information based on newly received parameters. The description of the same contents as the first embodiment of the present invention will not be repeated.

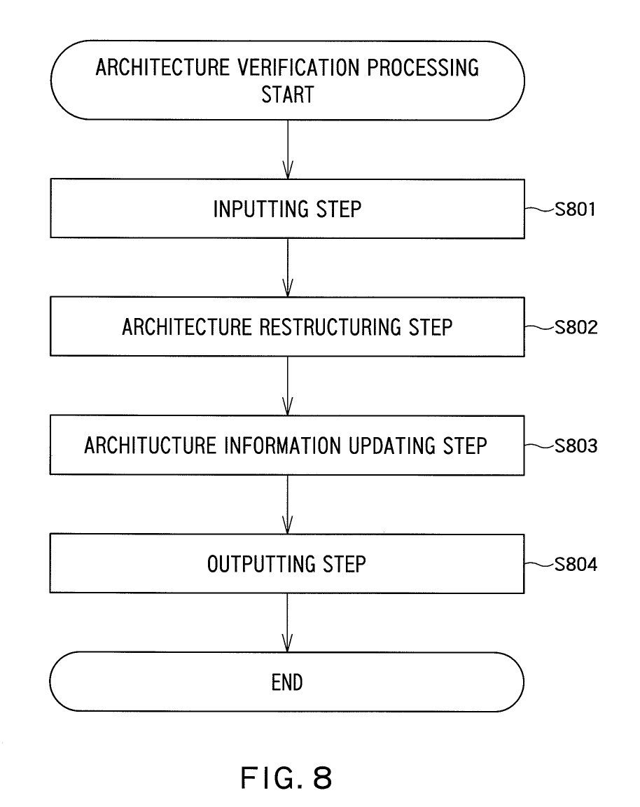

A configuration of the architecture verifying apparatus of the second embodiment of the present invention will be described with reference to FIG. 7. FIG. 7 is a block diagram illustrating the configuration of the architecture verifying apparatus 10 of the second embodiment of the present invention.

Referring to FIG. 7, the architecture verifying apparatus 10 includes the inputting unit 11, the bus monitor 12, the module monitor 13, the architecture information generator 14, an architecture restructuring unit 141, an architecture information updating unit 142, the memory 15, and the outputting unit 16. The bus monitor 12, module monitor 13, the architecture information generator 14, and the outputting unit 16 are similar to those of the first embodiment of the present invention.

Referring to FIG. 7, in addition to the limitation information on the architecture processing time, the input unit 11 is configured to receive a parameter having an influence on the architecture processing time from the inputting device 20. For example, as with the first embodiment of the present invention, when the user refers to the architecture information 15a of FIG. 6 to modify the architecture after the architecture information generator 14 generates the architecture information 15a, the user can input at least one of the parameters including a processing time of the module, a bus priority, and a bus configuration condition into the architecture verifying apparatus 10 using the inputting device 20.

Referring to FIG. 7, using the parameter received by the inputting unit 11, the architecture restructuring unit 141 is configured to restructure the architecture corresponding to architecture information 15a stored in the memory 15. For example, when the user feeds the parameters to change a bus width in the architecture performing the sound processing of FIG. 3B from 32 bits to 64 bits, the architecture restructuring unit 141 reads out the architecture information 15a from the memory 15, the architecture restructuring unit 141 changes the bus width in the architecture corresponding to the architecture information 15a to 64 bits, the architecture restructuring unit 141 changes the reception transaction Y3 and transmission transaction Y4, in which 32-bit burst transfer is performed twice, to 64-bit single transfer, and the architecture restructuring unit 141 changes the times necessary for the reception transaction Y3 and transmission transaction Y4 from the number of cycles (for example, four cycles) necessary for the burst transfer to the number of cycles (for example, two cycles) necessary for the single transfer to restructure the architecture. The numbers of cycles necessary for the burst transfer and single transfer are included in the limitation information received by the inputting unit 11.

Referring to FIG. 7, the architecture information updating unit 142 is configured to statically analyze the architecture restructured by the architecture restructuring unit 141 (that is, the architecture information updating unit 142 performs the analysis in the architecture verifying apparatus 10 without communicating with the system executing device 40) and to update the architecture information 15a stored in the memory 15 based on the analyzed result. For example, the architecture information updating unit 142 updates processing generation order and timing, which are included in the architecture information 15a of each piece of processing, using the new architecture information 15a.

Referring to FIG. 7, the memory is configured to store the architecture information 15a generated by the architecture information generator 14. The memory 15 is also configured to act as working memories of the architecture information generator 14 and architecture information updating unit 142.

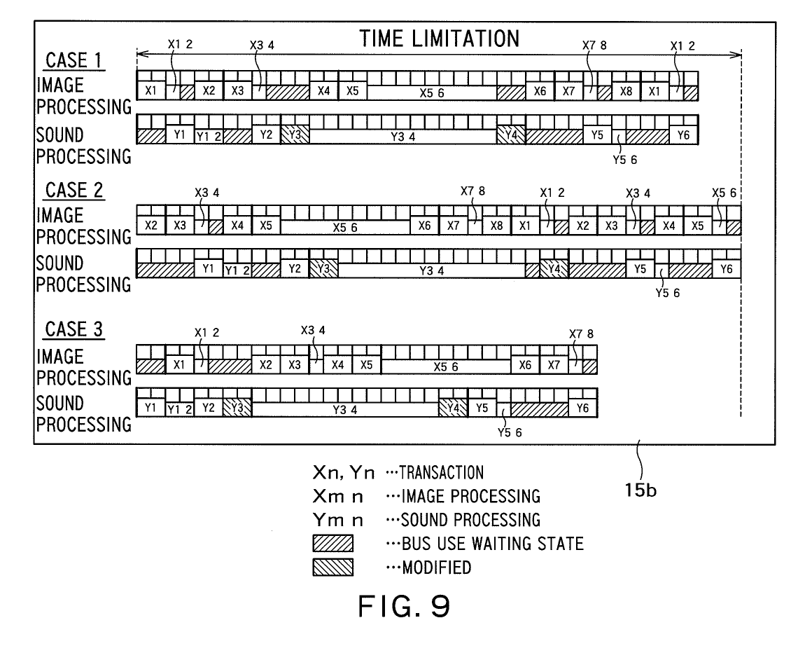

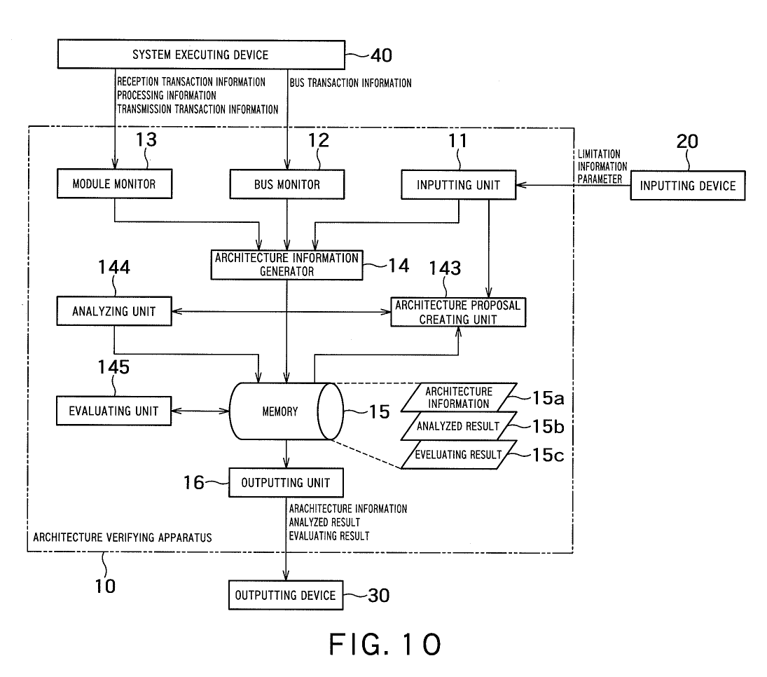

The processing performed by the architecture verifying apparatus of the second embodiment of the present invention will be described with reference to FIGS. 8 and 9. FIG. 8 is a flowchart illustrating processing procedures of the architecture verification processing of the second embodiment of the present invention. FIG. 9 schematically illustrates an output example of the second embodiment of the present invention.

Referring to FIG. 8, in the architecture verification processing of the second embodiment of the present invention, an inputting step is performed (Step S801). In the inputting step (Step S801), the parameter is received by the inputting unit 11 from the inputting device 20.

Then, an architecture restructuring step is performed (Step S802). In the architecture restructuring step (Step S802), the architecture restructuring unit 141 restructures the architecture corresponding to the architecture information 15a stored in the memory 15 using the parameter received in the inputting step (Step S801).

Then, an architecture information updating step is performed (Step S803). In the architecture information updating step (Step S803), the architecture information updating unit 142 statically analyzes the architecture restructured in the architecture restructuring step (Step S802), and the architecture information updating unit 142 updates the architecture information 15a stored in the memory 15 based on the analyzed result.

Then, an outputting step is performed (Step S804). In the outputting step (Step S804), the outputting unit 16 supplies the architecture information 15a stored in the memory 15 in the architecture information updating step (Step S803) to the outputting device 30. In an architecture proposal illustrated in FIG. 9, the transactions Y3 and Y4 are modified by performing the architecture verification processing of FIG. 8, and the case 1 to case 3 satisfy the specifications.

Referring to FIG. 8, the architecture verification processing of the second embodiment of the present invention is ended after the outputting step (Step S804).

According to the second embodiment of the present invention, as illustrated in FIG. 7, the architecture verifying apparatus 10 restructures the architecture using the parameter, the architecture verifying apparatus 10 statically analyzes the restructured architecture, and the architecture verifying apparatus 10 supplies the updated architecture information 15a to the outputting device 30 based on the analyzed result. Therefore, the architecture can be verified based on the parameter input by the user without re-operating the architecture on the system executing device 40.

### Third Embodiment

An architecture verifying apparatus according to a third embodiment of the present invention will be described below. The architecture verifying apparatus of the third embodiment of the present invention supplies an architecture proposal satisfying the specifications. The description of the same contents as the first and second embodiments of the present invention will not be repeated.

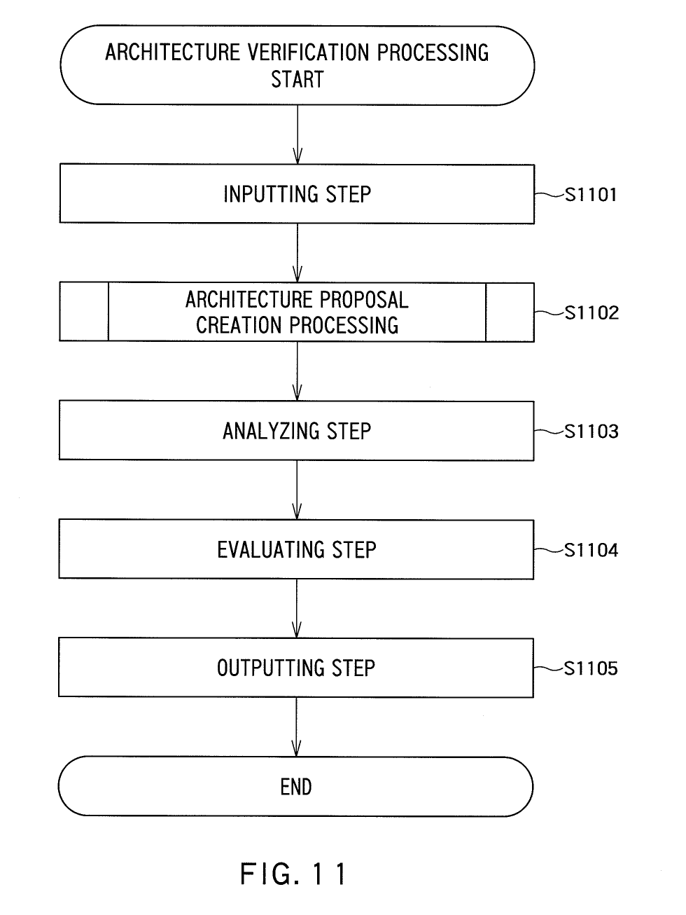

A configuration of the architecture verifying apparatus of the third embodiment of the present invention will be described with reference to FIG. 10. FIG. 10 is a block diagram illustrating the configuration of the architecture verifying apparatus 10 of the third embodiment of the present invention.

Referring to FIG. 10, the architecture verifying apparatus 10 includes the inputting unit 11, the bus monitor 12, the module monitor 13, the architecture information generator 14, an architecture proposal creating unit 143, an analyzing unit 144, an evaluating unit 145, the memory 15, and the outputting unit 16. The bus monitor 12, the module monitor 13, and the architecture information generator 14 are similar to those of the first embodiment of the present invention. The inputting unit 11 is similar to that of the second embodiment of the present invention.

Referring to FIG. 10, the architecture proposal creating unit 143 is configured to create the architecture proposal based on the limitation information and the parameter indicating the limitation for verifying the architecture, which are received by the inputting unit 11, and the architecture information 15a stored in the memory 15. For example, the architecture proposal creating unit 143 reads out the architecture information 15a from the memory 15, the architecture proposal creating unit 143 changes only the parameter of the architecture corresponding to the architecture information 15a, and the architecture proposal creating unit 143 creates all the architectures satisfying the limitation information as the architecture proposal.

Referring to FIG. 10, the analyzing unit 144 is configured to statically analyze the architecture proposal created by the architecture proposal creating unit 143 and to write an analyzed result 15b into the memory 15. For example, the analyzing unit 144 statically analyzes the architecture proposal created by the architecture proposal creating unit 143 together with the architecture information 15a, the analyzing unit 144 confirms whether the processing is ended within the time limitation for each case, and the analyzing unit 144 determines the architecture proposal whose processing is ended within the time limitation for each case as the analyzed result 15b.

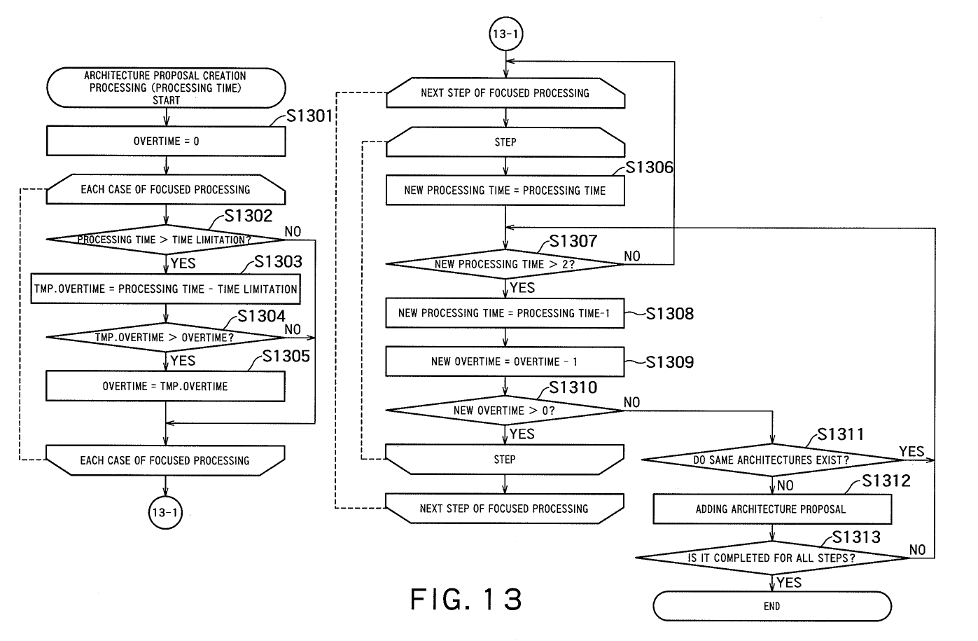

Referring to FIG. 10, the evaluating unit 145 is configured to evaluate the analyzed result 15b stored in the memory 15 based on the parameter received by the inputting unit 11 and to write an evaluated result 15c into the memory 15. For example, the evaluating unit 145 evaluates the plural architecture proposals (architecture proposals illustrated in FIGS. 12, 14, 16, and 18) included in the analyzed result 15b with a predetermined criterion of evaluation, and the evaluating unit 145 determines merits and demerits of the architecture proposals as the evaluated result 15c. For example, the criterion of evaluation is previously selected evaluation items (the processing time of the module constituting the processing, the bus priority, the bus width, and the bus configuration) or values previously weighted to the evaluation items. The criterion of evaluation and the parameter are received by the inputting unit 11. That is, the evaluated result 15c indicates an architecture proposal closest to the architecture proposal that the user expects in the plural architecture proposals. The evaluating unit 145 may be omitted.

Referring to FIG. 10, the memory is configured to store the architecture information 15a generated by the architecture information generator 14, the analyzed result 15b of the analyzing unit 144, and the evaluated result 15c of the evaluating unit 145. The memory 15 is also configured to act as working memories of the architecture information generator 14, analyzing unit 144, and evaluating unit 145.

Referring to FIG. 10, the outputting unit 16 is configured to supply the analyzed result 15b to the outputting device 30 in addition to the architecture information 15a stored in the memory 15. When the evaluated result 15c is stored in the memory 15, the outputting unit 16 supplies the analyzed result 15b and the evaluated result 15c to the outputting device 30.

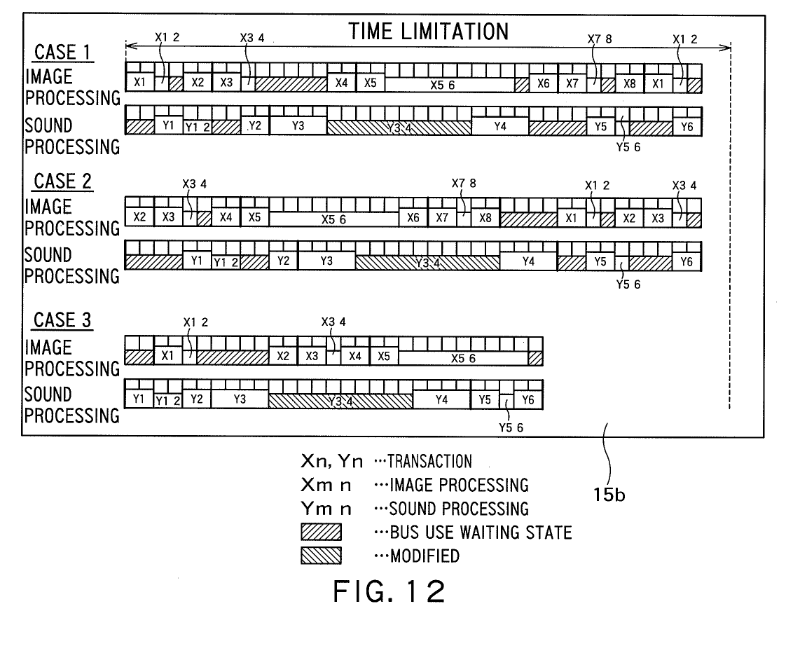

The processing performed by the architecture verifying apparatus of the third embodiment of the present invention will be described with reference to FIGS. 11 and 12. FIG. 11 is a flowchart illustrating processing procedures of the architecture verification processing of the third embodiment of the present invention. FIG. 12 schematically illustrates an output example of the third embodiment of the present invention.

Referring to FIG. 11, in the architecture verification processing of the third embodiment of the present invention, an inputting step is performed (Step S1101). The inputting step (Step S1101) is performed in the manner similar to that of the inputting step (Step S801 of FIG. 8) of the second embodiment of the present invention.

Then, an architecture proposal creation processing is performed (Step S1102). In the architecture proposal creation processing (Step S1102), the architecture proposal creating unit 143 creates the architecture proposal based on the limitation information and parameter, which are received in the inputting step (Step S1101), and the architecture information 15a stored in the memory 15. The detailed architecture proposal creation processing (Step S1102) is described later.

Then, an analyzing step is performed (Step S1103). In the analyzing step (Step S1103), the analyzing unit 144 statically analyzes the architecture proposal created in the architecture proposal creation processing (Step S1102), and the analyzing unit 144 writes the analyzed result 15b into the memory 15.

Then, an evaluating step is performed (Step S1104). In the evaluating step (Step S1104), the evaluating unit 145 evaluates the analyzed result 15b stored in the memory 15 based on the parameter received in the inputting step (Step S1101), and the evaluating unit 145 writes the evaluated result 15c into the memory 15.

Then, an outputting step is performed (Step S1105). In the outputting step (Step S1105), the outputting unit 16 supplies the analyzed result 15b of the analyzing step (Step S1103) and the evaluated result 15c of the evaluating step (Step S1104) to the output device 30. At this time, the outputting unit 16 supplies the analyzed result 15b of FIG. 12 to the outputting device 30. In the architecture proposal of FIG. 12, the sound processing Y3_4 is shortened by three cycles by performing the architecture verification processing of FIG. 11, and the case 1 to case 3 satisfy the specifications.

Referring to FIG. 11, the architecture verification processing of the third embodiment of the present invention is ended after the outputting step (Step S1105).

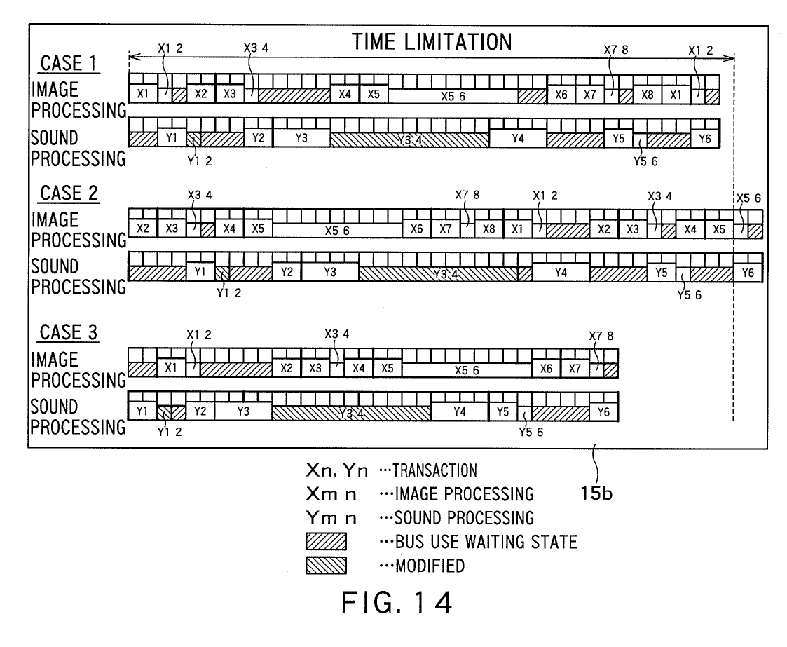

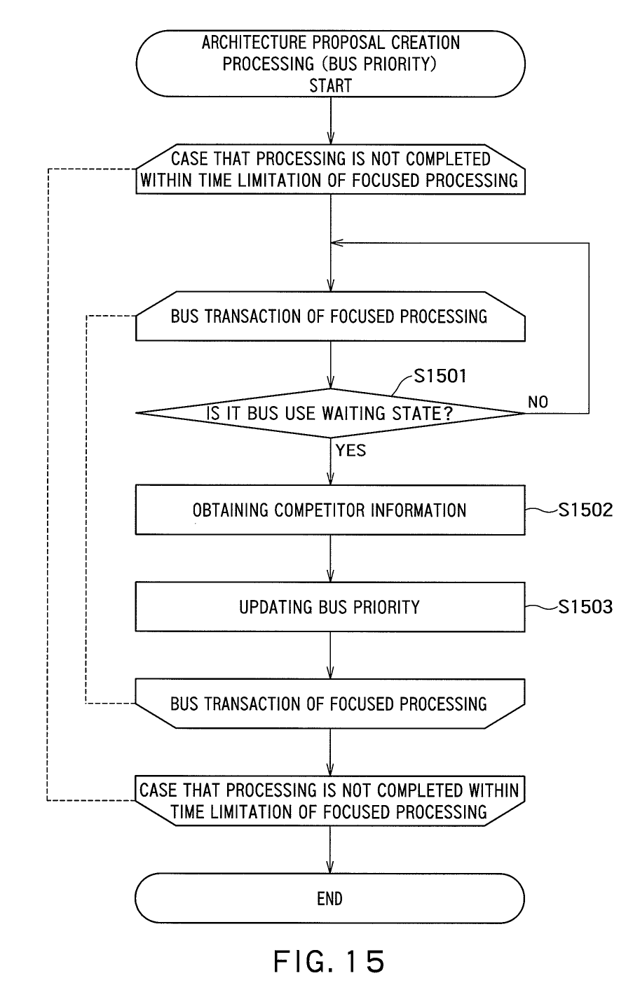

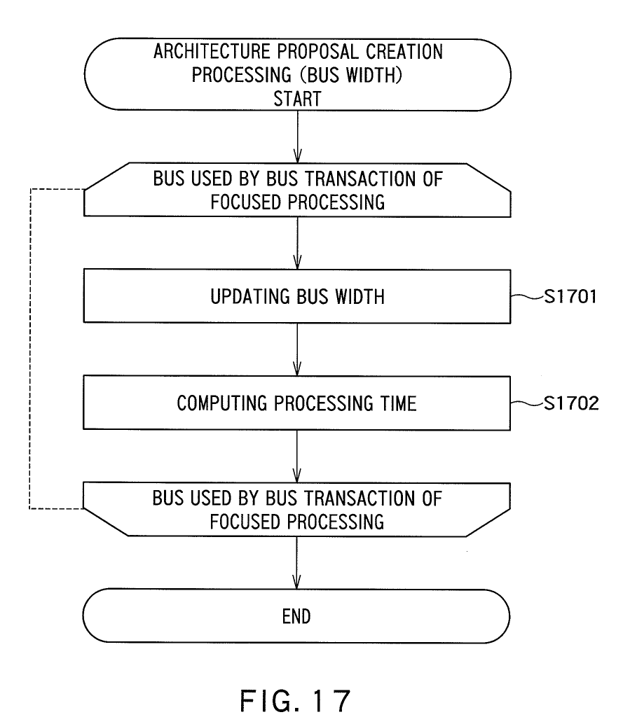

Then architecture proposal creation processing (Step S1102 of FIG. 11) when the module processing time is fed as the parameter will be described with reference to FIGS. 13, 14, and 16. FIG. 13 is a flowchart illustrating processing procedures of the architecture proposal creating unit 143 in the architecture proposal creation processing (Step S1102 of FIG. 11) when the module processing time is fed as the parameter. FIGS. 14 and 16 schematically illustrate output examples of the third embodiment of the present invention when the architecture proposal creation processing of FIG. 13 is performed.

Referring to FIG. 13, first an initial value of zero is set to a variable of “overtime” (Step S1301).

Then, a magnitude correlation between the module processing time and time limitation, which are received by the inputting unit 11, is determined for each case of the focused processing (Step S1302). The flow goes to Step S1303 when the module processing time is more than the time limitation (YES in Step S1302), and it is determined for a different case when the module processing time is equal to or lower than the time limitation (NO in Step S1302).

When the module processing time is more than time limitation (YES in Step S1302), as illustrated in FIG. 13, a value of “processing time—time limitation” is set to a variable of “Tmp. overtime” (Step S1303).

Then, a magnitude correlation between the variable of “Tmp. overtime” and the variable of “overtime” is determined (Step S1304). The flow goes to Step S1305 when the variable of “Tmp. overtime” is more than the variable of “overtime” (YES in Step S1304), and it is determined for a different case when the variable of “Tmp. overtime” is equal to or lower than the variable of “overtime” (NO in Step S1304).

When the variable “Tmp. overtime” is more than the variable of “overtime” (YES in Step S1304), the value of the variable of “Tmp. overtime” is set to the variable “overtime” (Step S1305).

Steps S1302 to S1305 are repeated in each case. That is, in Steps S1302 to S1305, a maximum value of a difference (overtime) between the processing time and the time limitation is obtained in all the cases of the focused processing in which the processing time is more than the time limitation.

After Steps S1302 to S1305 are repeated for all the cases, a value of variable of “processing time” is set to a variable of “new processing time” for the focused processing (Step S1306).

Then, a magnitude correlation between the variable of “new processing time” and 2 is determined (Step S1307). The flow goes to Step S1308 when the variable of “new processing time” is more than 2 (YES in Step S1307), and a next processing is focused when the variable of “new processing time” is equal to or lower than 2 (NO in Step S1307).

When the variable of “new processing time” is more than 2 (YES in Step S1307), a value of “processing time−1” is set to the variable of “new processing time” (Step S1308).

Then, a value of “overtime−1” is set to the variable “of new overtime” (Step S1309).

Then, a magnitude correlation between the variable of “new overtime” and 0 is determined (Step S1310). The next processing is focused when the variable of “new overtime” is more than 0 (YES in Step S1310), and the flow goes to Step S1311 when the variable of “new overtime” is equal to or lower than 0 (NO in Step S1310).

When the variable of “new overtime” is equal to or lower than 0 (NO in Step S1310), a determination whether the same architectures exist as the architecture proposal (Step S1311). The flow returns to Step S1307 when the same architectures exist as the architecture proposal (YES in Step S1311), and the flow goes to Step S1312 when the same architectures do not exist as the architecture proposal (NO in Step S1311).

Steps S1306 to S1310 are repeated in each focused processing. In Steps S1306 to S1310, because the processing cannot be performed when the processing time becomes zero, it is necessary that the new processing time be equal to or more than one cycle.

When the same architectures do not exist as the architecture proposal (YES in Step S1311), the architecture focused in Steps S1302 to S1305 is added as the architecture proposal satisfying the limitation information (Step S1312).

Then, a determination whether the processing of FIG. 13 is completed for all the steps is made (S1313). The flow returns to Step S1307 when the processing of FIG. 13 is not completed for all the steps (NO in S1313), and the processing of FIG. 13 is ended when the processing is completed for all the steps (YES in S1313).

When the architecture proposal creation processing (Step S1102 of FIG. 11) of FIG. 13 is performed, in the outputting step (Step S1105 of FIG. 11), the outputting unit 16 supplies the analyzed result 15b illustrated in FIGS. 14 and 16 to the outputting device 30. In the architecture proposal of FIG. 14, by performing the architecture proposal creation processing of FIG. 13, the sound processing Y1_2 is shortened by one cycle, and the sound processing Y3_4 is shortened by two cycles. That is, FIG. 14 illustrates the architecture proposal (the architecture proposal that is not included in the analyzed result 15b) in which the case 1 and case 3 satisfy the specifications while the case 2 does not satisfy the specifications. On the other hand, in the architecture proposal of FIG. 16, the sound processing Y3_4 is shortened by three cycles by performing the architecture proposal creation processing of FIG. 13. That is, FIG. 16 illustrates the architecture proposal (the architecture proposal that is included in the analyzed result 15b) in which the case 1 to case 3 satisfy the specifications.

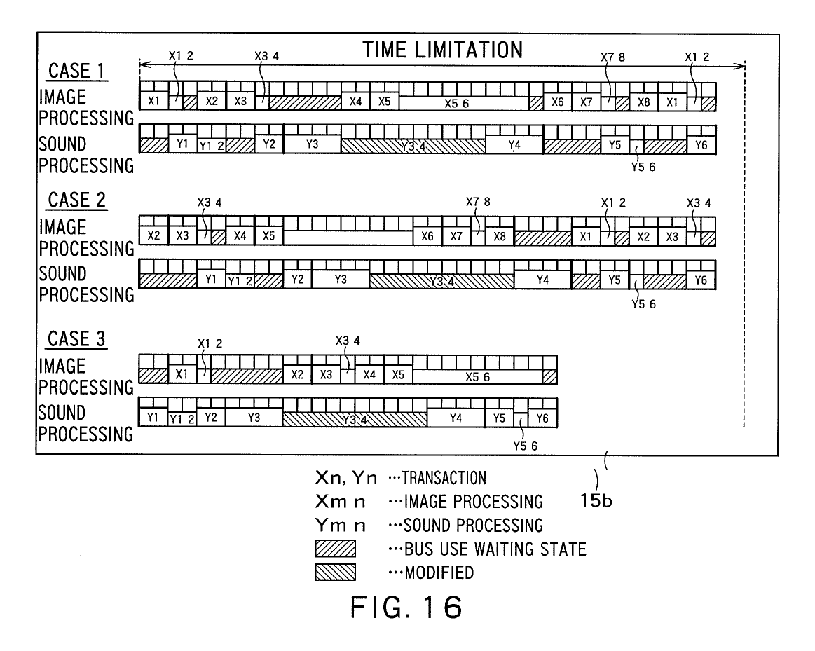

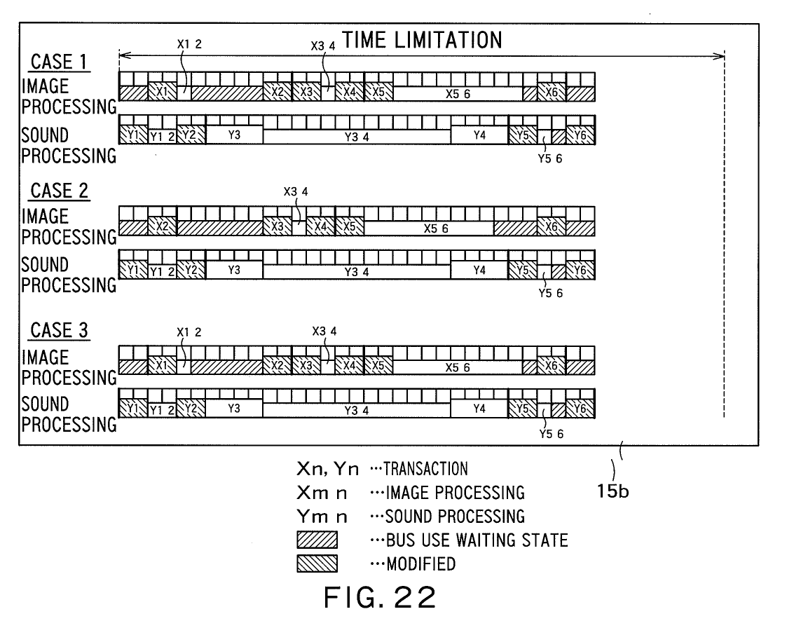

The architecture proposal creation processing (Step S1102 of FIG. 11) when the bus priority is fed as the parameter will be described with reference to FIGS. 15 and 22. FIG. 15 is a flowchart illustrating processing procedures of the architecture proposal creating unit 143 in the architecture proposal creation processing (Step S1102 of FIG. 11) when the bus priority is fed as the parameter. FIG. 22 schematically illustrates an output example of the third embodiment of the present invention when the architecture proposal creation processing of FIG. 15 is performed.

Referring to FIG. 15, a determination whether the bus use waiting state exists due to the bus competition is made for the bus transaction of the case in which the processing is not ended within the time limitation of the focused processing, (Step S1501). The flow goes to Step S1502 when the bus use waiting state exists due to the bus competition (YES in Step S1501), and it is determined for another bus transaction when the bus use waiting state does not exist due to the bus competition (NO in Step S1501).

When the bus use waiting state exists due to the bus competition (YES in Step S1501), as illustrated in FIG. 15, the identification information on the module using the bus (hereinafter referred to as “competitor information”) is obtained in the bus use waiting state (Step S1502).

Then, the bus priority is updated such that the priority to the focused module is increased rather than the module corresponding to the competitor information obtained in Step S1502 (Step S1503).

Then, Steps S1501 to S1503 are repeated in each case in which the processing is not ended within the time limitation of the focused processing and in each bus transaction of the case (that is, until the check whether the bus use waiting state exists due to the bus competition is completed for all the bus transactions of the focused processing)

When the architecture proposal creation processing (Step S1102 of FIG. 11) of FIG. 15 is performed, in the outputting step (Step S1105 of FIG. 11), the outputting unit 16 supplies the analyzed result 15b of FIG. 22 to the outputting device 30. In the architecture proposal of FIG. 22, the transactions X1 to X6, Y1, Y2, Y5, and Y6 are modified by performing the architecture proposal creation processing of FIG. 15, and the case 1 to case 3 satisfy the specifications (that is, included in the analyzed result 15b).

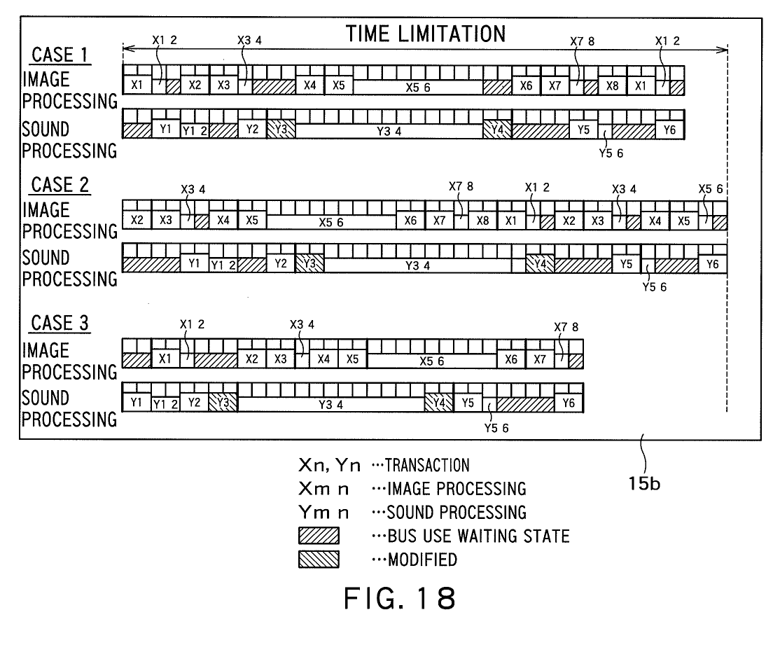

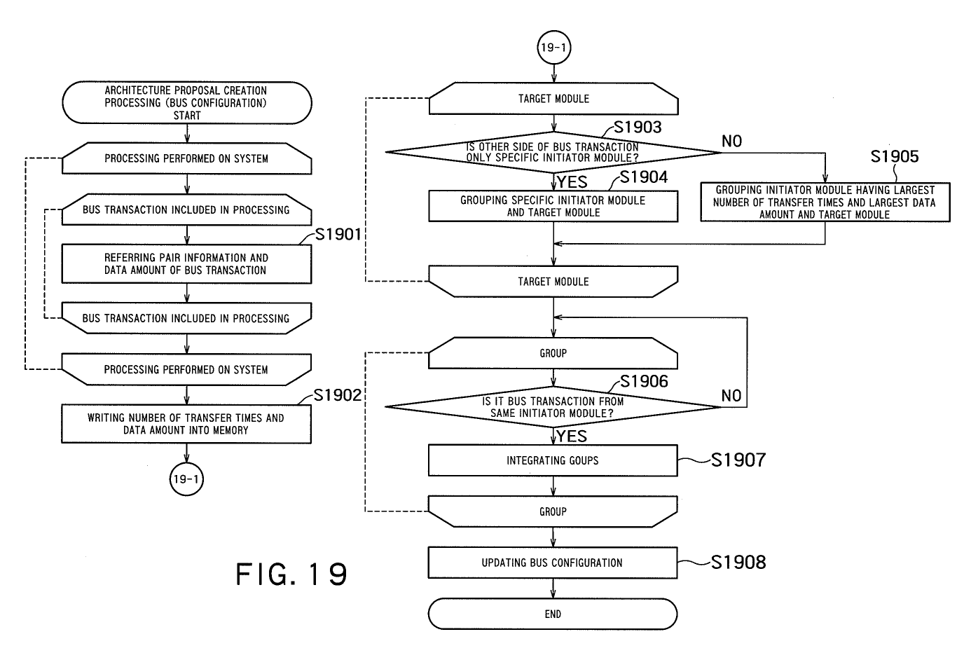

The architecture proposal creation processing (Step S1102 of FIG. 11) when the bus width is fed as the parameter will be described with reference to FIGS. 17 and 18. FIG. 17 is a flowchart illustrating processing procedures of the architecture proposal creating unit 143 in the architecture proposal creation processing (Step S1102 of FIG. 11) when the bus width is fed as the parameter. FIG. 18 schematically illustrates an output example of the third embodiment of the present invention when the architecture proposal creation processing of FIG. 17 is performed.

Referring to FIG. 17, the bus width is updated so as to be extended from 32 bits to 64 bits for the bus used by the bus transaction of the focused processing (S1701).

Then, the processing time of the bus transaction using the bus is computed based on the bus width extended in Step S1701 and the data amount transmitted in the bus transaction, and the processing time is updated (Step S1702).

Referring to FIG. 17, Steps S1701 and S1702 are repeated in each bus used in the bus transaction of the focused processing.

When the architecture proposal creation processing (Step S1102 of FIG. 11) of FIG. 17 is performed, in the outputting step (Step S1105 of FIG. 11), the outputting unit 16 supplies the analyzed result 15b of FIG. 18 to the outputting device 30. In the architecture proposal of FIG. 18, the transaction Y3 and Y4 are modified by performing the architecture proposal creation processing of FIG. 17, the case 1 to case 3 satisfy the specifications (that is, included in the analyzed result 15b).

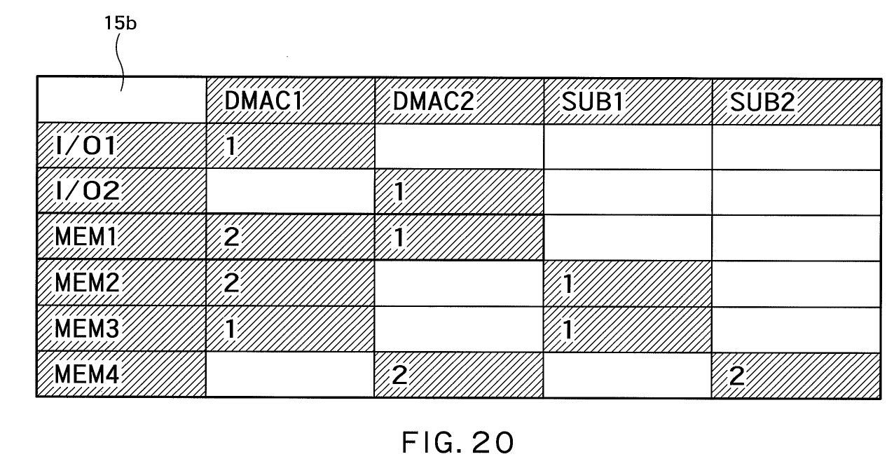

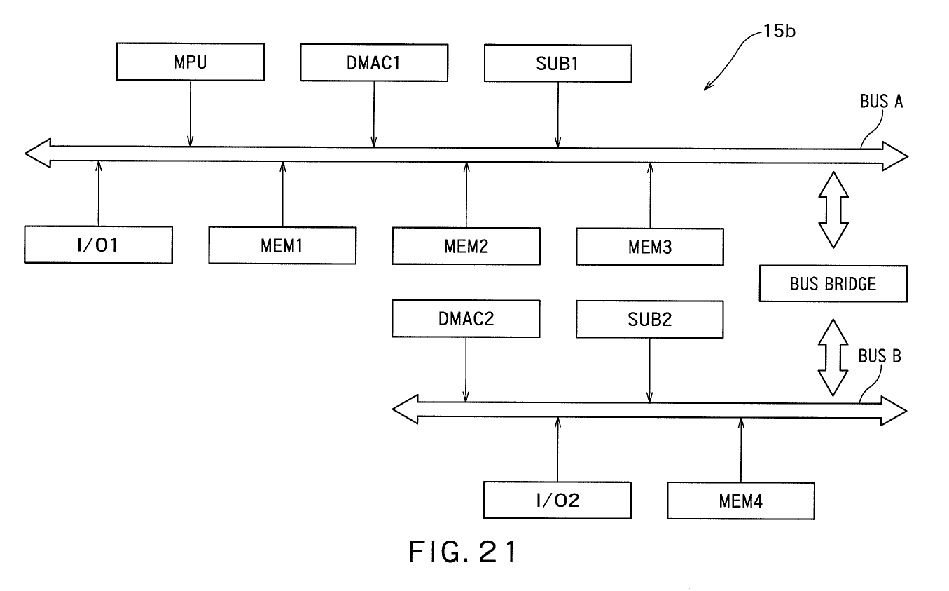

The architecture proposal creation processing (Step S1102 of FIG. 11) when the bus configuration is fed as the parameter will be described with reference to FIGS. 19 to 21. FIG. 19 is a flowchart illustrating processing procedures of the architecture proposal creating unit 143 in the architecture proposal creation processing (Step S1102 of FIG. 11) when the bus configuration is fed as the parameter. FIGS. 20 and 21 schematically illustrate output examples of the third embodiment of the present invention when the architecture proposal creation processing of FIG. 19 is performed.

Referring to FIG. 19, the pair information and data amount, which are obtained by the bus monitor 12 of FIG. 10, are referred to, for the bus transaction included in the processing performed on the system (S1901).

Referring to FIG. 19, Step S1901 is repeated in each bus transaction included in the processing performed on the system.

Then, the number of transfer times and the data amount, which are included in the bus transaction information obtained by the bus monitor 12, are written into the memory 15 in each pair indicated by the pair information referred to in Step S1901 (Step S1902).

Then, the specific initiator module and the target module are grouped together (Step S1904) when the other side of the bus transaction of the target module is only the specific initiator module (YES in Step S1903).

On the other hand, the initiator module, which has the largest number of transfer times and the largest data amount, and the target module are grouped together (Step S1905) when the other side of the bus transaction of the target module is not only the specific initiator module (NO in Step S1903). When a plurality of the initiator modules having the largest data amount exists, the initiator module earliest found and the target module are grouped together.

Steps S1903 to S1905 are repeated in each target module as illustrated in FIG. 19.

Then, when the groups made in Steps S1904 or S1905 include the bus transactions from the same initiator module (YES in Step S1906), the groups are integrated (S1907).

On the other hand, when the groups made in Steps S1904 or S1905 do not include the bus transactions from the same initiator module (NO in Step S1906), the next group is focused.

Steps S1906 and S1907 are repeated in each group made in Step S1904 or S1905.

Then, the bus configuration is updated based on the group integrated in Step S1907 (Step S1908).

The architecture proposal creation processing (Step S1102 of FIG. 11) when the bus configuration is fed as the parameter is ended after Step S1908.

When the architecture proposal creation processing (Step S1102 of FIG. 11) of FIG. 19 is performed, in the outputting step (Step S1105 of FIG. 11), the outputting unit 16 supplies the analyzed result 15b illustrated in FIGS. 20 and 21 to the outputting device 30. In FIG. 20, as a result of Step S1907 of FIG. 19, the plural modules are integrated in the group including the input/output interface I/O1, the memories MEM1 to MEM3, the memory controller DMAC1, and the sub-processor SUB1, and the group including the input/output interface I/O2, the memory MEM4, the memory controller DMAC2, and the sub-processor SUB2. FIG. 21 illustrates the architecture having the bus configuration corresponding to the output example of FIG. 20.

Alternatively, the architecture proposal may be created by a combination of the processing time, the bus priority, the bus width, and the bus configuration.

According to the third embodiment of the present invention, as illustrated in FIG. 10, the user feeds the parameter into the architecture verifying apparatus 10 using the inputting device 20, the architecture information 15a of the architecture proposal satisfying the time limitation is displayed using the parameter, the bus transaction information, the reception transaction information, the processing information, and the transmission transaction information. Therefore, the work load for improving the architecture of the user can be reduced.

According to the third embodiment of the present invention, as illustrated in FIG. 10, the architecture proposal is created by changing only the parameter fed by the user. Therefore, the time necessary to create the architecture proposal can be shortened.

According to the third embodiment of the present invention, as illustrated in FIG. 10, the architecture verifying apparatus 10 evaluates the plural architecture proposals, and the architecture verifying apparatus 10 supplies the analyzed result 15b and the evaluated result 15c to the outputting device 30. Therefore, the user can easily find the optimum architecture.

At least part of the architecture verifying apparatus 10 of the embodiments of the present invention may be formed by either hardware or software. When at least part of the architecture verifying apparatus 10 of the embodiments of the present invention may be formed by the software, a program realizing at least part of the function of the architecture verifying apparatus 10 may be stored in a recording medium such as a flexible disk and CD-ROM, and the program may be read and executed by a computer. The recording medium is not limited to detachable recording media such as a magnetic disk and an optical disk, but the recording medium may be fixed recording media such as a hard disk drive and a memory.

The program realizing at least part of the function of the architecture verifying apparatus 10 of the embodiments of the present invention may be distributed through communication lines (including wireless communication) such as the Internet. The encrypted, modulated, or compressed, program may be distributed through wired lines such as the Internet or wireless lines, or the encrypted, modulated, or compressed, program may be distributed while stored in the recording medium.

What is claimed is:

1. An architecture verifying apparatus comprising:
an input module configured to receive time constraint information on a processing time of an architecture comprising a plurality of modules and a bus;
a bus monitor configured to monitor a bus transaction in order to obtain bus transaction information, the bus transaction being issued when each module utilizes the bus;
a module monitor configured to monitor a reception transaction issued when each module receives data, a process executed to the data by each module, and a transmission transaction issued when each module transmits the data in order to obtain reception transaction information on the reception transaction, process information indicating contents of the process and a processing time of each module, and transmission transaction information on the transmission transaction;
an architecture information generator configured to associate the time constraint information received by the input module and the bus transaction information obtained by the bus monitor with the reception transaction information, the process information, and the transmission transaction information obtained by the module in order to generate architecture information; and
an outputting module configured to supply the architecture information generated by the architecture information generator.

2. The apparatus of claim 1, further comprising:
a memory configured to store the architecture information generated by the architecture information generator;
an architecture restructuring module configured to restructure the architecture corresponding to the architecture information in the memory using a parameter indicative of an influence on the processing time of the architecture; and
an architecture information updating module configured to analyze the architecture restructured by the architecture restructuring module, and to update the architecture information in the memory,
wherein the outputting module is configured to supply the architecture information updated by the architecture information updating module.

3. The apparatus of claim 2, wherein the parameter comprises at least one of the processing time of each module, a bus priority, and a bus configuration condition.

4. The apparatus of claim 1, further comprising:
a memory configured to store the architecture information generated by the architecture information generator;
an architecture suggestion generating module configured to generate a architecture suggestion based on the time constraint information received by the input module, a parameter indicative of an influence on the processing time of the architecture received by the input module, and the architecture information in the memory;
an analyzer configured to analyze the architecture suggestion generated by the architecture suggestion generating unit,
wherein the outputting module is configured to supply a result of the analyzer.

5. The apparatus of claim 4, further comprising an evaluating module configured to evaluate the analyzed result based on a predetermined criterion of evaluation,
wherein the outputting module is configured to supply a result of the evaluating module and the analyzed result.

6. The apparatus of claim 5, wherein the parameter comprises at least one of a processing time of each module, a bus priority, and a bus configuration condition.

7. The apparatus of claim 4, wherein the architecture suggestion generating module is configured to change only the parameter corresponding to the architecture information stored in the memory in order to generate all the architectures satisfying the time constraint information as the architecture suggestion.

8. The apparatus of claim 4, wherein the parameter comprises at least one of a processing time of each module, a bus priority, and a bus configuration condition.

9. The apparatus of claim 1, wherein the outputting module is configured to supply the architecture information into a database.

10. An architecture verifying method comprising:
receiving time constraint information on a processing time of an architecture comprising a plurality of modules and a bus;
monitoring a bus transaction in order to obtain bus transaction information, the bus transaction being issued when each module utilizes the bus;
monitoring a reception transaction issued when each module receives data, a process executed to the data by each module, and a transmission transaction issued when each module transmits the data in order to obtain reception transaction information on the reception transaction, process information indicating contents of the process and a processing time of each module, and transmission transaction information on the transmission transaction;
associating the time constraint information and the bus transaction information with the reception transaction information, process information, and the transmission transaction information in order to generate architecture information; and
supplying the architecture information.

11. The method of claim 10, further comprising:
restructuring an architecture corresponding to the architecture information using a parameter indicative of an influence on the processing time of the architecture;
analyzing the restructured architecture restructured;
updating the architecture information; and
supplying the updated architecture information.

12. The method of claim 11, wherein the parameter comprises at least one of the processing time of each module, a bus priority, and a bus configuration condition.

13. The method of claim 10, further comprising:
generating an architecture suggestion based on the time constraint information, a parameter indicative of an influence on the processing time of the architecture, and the architecture information;
analyzing the generated architecture suggestion; and
supplying an analyzed result.

14. The method of claim 13, further comprising:
evaluating the analyzed result based on a predetermined criterion of evaluation; and
supplying an evaluated result in the evaluating and the analyzed result in the analyzing.

15. The method of claim 14, wherein the parameter comprises at least one of a processing time of each module, a bus priority, and a bus configuration condition.

16. The method of claim 13, further comprising:
changing only the parameter corresponding to the architecture information in order to create all the architectures satisfying the time constraint information as the architecture suggestion.

17. The method of claim 13, wherein the parameter comprises at least one of the processing time of each module, a bus priority, and a bus configuration condition.

18. The method of claim 10, further comprising supplying the architecture information into a database.

19. A medium storing architecture verifying program comprising:
an inputting instruction configured to receive time constraint information on a processing time of an architecture comprising a plurality of modules and a bus;
a bus monitoring instruction configured to monitor a bus transaction in order to obtain bus transaction information, the bus transaction being issued when each module utilizes the bus;
a module monitoring instruction configured to monitor a reception transaction issued when each module receives data, a process executed to the data by each module, and a transmission transaction issued when each module transmits the data in order to obtain reception transaction information on the reception transaction, process information indicating contents of the process and a processing time of each module, and transmission transaction information on the transmission transaction;
an architecture information generator configured to associate the time constraint information received by the inputting instruction and the bus transaction information obtained by the bus monitoring instruction with the reception transaction information, the process information, and the transmission transaction information obtained by the module to generate architecture information; and
an outputting instruction configured to supply the architecture information generated by the architecture information generator.

20. The medium of claim 19, further comprising:
an architecture restructuring instruction configured to restructure the architecture corresponding to the architecture information using a parameter indicative of an influence on the processing time of the architecture; and
an architecture information updating instruction configured to analyze the architecture restructured by the architecture restructuring instruction, and to update the architecture information,
wherein the outputting instruction is configured to supply the architecture information updated by the architecture information updating instruction.
